(19) United States
(12) Patent Application Publication
(10) Pub. No.: US 2023/0264453 A1
(43) Pub. Date: Aug. 24, 2023

(54) COMPOSITE MATERIAL

(71) Applicant: SGL CARBON SE, Wiesbaden (DE)

(72) Inventors: Fabian SCHUBERT, Meitingen (DE); Thomas KOECK, Meitingen (DE); Werner LANGER, Meitingen (DE); Jurgen JOOS, Meitingen (DE)

(73) Assignee: SGL CARBON SE, Wiesbaden (DE)

(21) Appl. No.: 18/005,439

(22) PCT Filed: Jul. 16, 2021
(86) PCT No.: PCT/EP2021/070046

§ 371 Date: Jan. 13, 2023

(30) Foreign Application Priority Data
Jul. 16, 2020 (DE) 10 2020 208 931.0

(51) Int. Cl. B32B 9/04; B32B 3/26; B32B 5/02; B32B 9/00

(52) U.S. Cl. CPC B32B 9/047; B32B 3/266; B32B 5/022; B32B 5/024; B32B 9/007; B32B 9/045; B32B 5/26

(57) ABSTRACT

Composite materials used as fire protection panels.

### FIELD

The present invention relates to the use of composite materials as a fire protection panel and/or a heat dissipation panel.

In the context of the invention, a fire protection panel and/or a heat dissipation panel is understood to be a cladding element which is shaped as a sheet or curved sheet and can have a load-bearing function.

### BACKGROUND

Intumescent materials have been used in fire protection applications up to now. For this purpose, graphite salts, i.e. expanded graphites, are often used, which are embedded in composite resin or incorporated in mineral fibre knitted fabrics. This is described, for example, in WO2018/094002A1.

In particular, the mineral fire protection solutions have comparatively high material thicknesses of the fire protection layer with a corresponding fire protection effect and are also not very flexible. When used in load-bearing components or structural elements, the relatively weak fire protection layer must be connected to a load-bearing material. On the one hand, the connection point between the fire protection layer and the load-bearing material as well as the resulting total thickness of the composite material are problematic. The resulting limited design freedom results, for example, in quite high thicknesses for fire protection doors and thus also in relatively high weights. This in turn results in doors that are often difficult to open and close, requiring increased effort. In addition, common composite materials lack the flexibility of being mouldable. Furthermore, in case of fire, a critical amount of smoke and/or toxic fumes may be released due to chemical decomposition of the composite matrix. In addition, a threshold temperature is required for intumescent materials, which then only results in the fire protection layer used being inflated.

### SUMMARY

The object of the present invention is therefore the provision and use of a composite material as a fire protection panel and/or heat dissipation panel which overcomes the above disadvantages of the prior art.

The object is achieved by using a composite material comprising fibres and graphite foil as a fire protection panel and/or heat dissipation panel.

To produce graphite foils, expanded graphite having a worm-like structure must first be produced. For this purpose, graphite, such as natural graphite, is usually mixed with an intercalate, such as nitric acid or sulphuric acid, and heat-treated at an elevated temperature of, for example, 600° C. to 1200° C. (DE10003927A1)

Expanded graphite is expanded in the plane perpendicular to the hexagonal carbon layers by a factor of 80 or more, for example, compared to natural graphite. Due to the expansion, expanded graphite is characterised by excellent mouldability and good interlocking properties. The expanded graphite can be pressed into foil form by means of pressure. Preferably, a foil having a density of 1.3 to 1.8 g/cm³ is used. A foil having this density range has thermal conductivities of 300 W/(mK) to 500 W/(mK) in the plane. The thermal conductivity is determined using the Ångström method (“Ångström's Method of Measuring Thermal Conductivity”; Amy L. Lytle; Physics Department, The College of Wooster, Theses).

Due to the material system used, weight and thickness savings are possible while maintaining the same load-bearing capacity as conventional fire protection panels. The use of graphite foil does not result in strong changes in shape in the event of fire, as is the case when using expanded graphites, which is due to the expansion of the graphite salt in the case of expanded graphite. In addition, the composite material used offers the advantage of mouldability, so that the composite material can assume a wide variety of geometries. This allows for a much more variable use than with conventional fire protection and/or heat dissipation panels. Furthermore, the composite material has a good thermal insulating effect in the z direction (thermal conductivity of 5 W/(mK), i.e. through the graphite foil and has a very good thermal conductivity (300 W/(mK) to 500 W/(mK)) within the plane (X and Y direction) of the graphite foil.

According to the invention, the fibres and the graphite foil are each arranged as at least one layer on top of one another.

The composite material typically has two outer surfaces.

If a graphite foil layer forms an outer surface, then this should face the potential heat source when in use, as this allows the graphite foil to dissipate the heat particularly effectively and not allow any gases and smoke that may be produced to escape.

In another advantageous embodiment, the fibres are embedded in a matrix.

According to the invention, the matrix is made of a plastics material.

In a further advantageous embodiment, the plastics material is selected from the group consisting of thermoplastics, elastomers, or duromers or mixtures thereof, preferably thermosets or thermoplastics.

Duromers are, for example, epoxy resins; thermoplastics are, for example, polyamides; and elastomers are, for example, acrylonitrile butadiene rubber; or thermoplastics are plastics materials that can be deformed within a certain temperature range, the process being reversible as long as the thermoplastic does not decompose due to thermal overheating.

By using plastics material as a matrix, it acts as a bonding material, with the plastics material and the graphite foil forming a form-fit connection. No adhesives are necessary for the connection. This has the advantage that the properties of the matrix determine the connection strength and the connection is not weakened as when using adhesives. When using epoxy resins, flame retardants can optionally be added. Flame retardants prevent the epoxy resin from catching fire and reduce smoke development and promote self-extinction. For example, aluminium hydroxide, ammonium phosphate, chlorinated or brominated copolymers such as decabromodiphenyl ether (DecaBDE), tetrabromobisphenol A (TBBPA) or hexabromocyclododecane (HBCD) can be used as flame retardants.

According to the invention, the fibres are selected from the group consisting of carbon fibres, glass fibres, aramid fibres, metal fibres, ceramic fibres, natural fibres and basalt fibres or mixtures thereof, preferably carbon fibres.

Natural fibres are understood to be flax, jute, sisal and hemp fibres.

According to the invention, the fibres are in the form of short fibres, long fibres, continuous fibres, rovings, woven fabrics, scrims, nonwovens or mixtures thereof.

Rovings are understood to be fibre strands that comprise one or more bundles of individual fibre filaments. A scrim is a textile surface structure in which a plurality of rovings is brought together. Woven fabrics are textile fabrics having at least two thread systems that do not run parallel and thus intersect. A nonwoven material is understood to be a structure having an isotropic fibre orientation in the surface without a preferred surface direction.

According to an advantageous embodiment, the graphite foil has a thickness of 0.15 to 2 mm, preferably 0.5 to 1 mm.

With a thickness of more than 2 mm, the graphite foil is less flexible, i.e. the graphite foil becomes brittle. If the thickness is less than 0.15 mm, the fire protection effect is no longer sufficient.

In another advantageous embodiment, the graphite foil has holes.

The holes can be of any shape. They can be triangular, square, pentagonal, hexagonal, round or oval, for example. The ratio of length to width of the holes is not limited. In preferred embodiments, the holes are round or oval. Round holes are particularly easy to make by punching, which favours a particularly efficient production of the. A perforation process to produce the holes is also possible. The area of each individual hole is in the range of 0.1 mm² to 400 mm², preferably in the range of 1 mm² to 100 mm². The distribution of the holes on the graphite foil is not limited.

In a composite material according to the invention, at least some of the holes are at least partially filled with resin. This provides further stabilisation of the composite material, as the holes in the graphite foil allow the layer on one side to bond to the layer on the other side.

Thus, the mechanical stability is increased. Similarly, in the case of a composite material consisting of a graphite foil having holes and a layer on one side of the graphite foil, the stability is increased by the resin penetrating into the holes of the graphite foil. In the context of the invention, “at least some of the holes” means that it is not necessary for all the holes to be filled with resin. “At least partially filled with resin” means that it is sufficient that at least 50% of the hole is filled with resin for a foil thickness of less than 1 mm, and at least 30% of the hole is filled with resin for a film thickness of more than 1 mm.

The composite material according to the invention is produced by a resin impregnation process such as the wet pressing process. The reinforcing fibres of the composite material, for example glass and/or carbon fibres, preferably glass fibres, are provided dry in the form of layers cut from textiles, preferably woven fabrics, scrims or nonwovens. These layers are stacked in the desired orientations of the fibres together with one or more layers of the graphite foil. Liquid, non-reacted synthetic resin, preferably epoxy resin, is applied either several times between the layers or only on the top side of the stack. Synthetic resin is understood to be a mixture of resin and hardener. The resin may additionally be mixed with the flame retardant additives described above. The stack of textile layers and graphite foils wetted with the liquid resin is inserted between the mould halves of a pressing tool and this is closed, usually with the aid of a press. The closing pressure on the one hand presses the layers into the desired shape for the fire protection and/or heat dissipation panel and on the other hand impregnates the dry textile layers with the liquid synthetic resin. Due to the holes in the graphite foil, it can also be well impregnated and firmly incorporated into the composite. The resin then reacts out to form the solid matrix material, usually accelerated by an increased temperature of the mould. The finished panel can then be removed from the mould.

According to a further advantageous embodiment, the graphite foil has a protective film. The protective film protects the graphite foil against scratches and abrasion. In addition, the protective film enhances the paintability.

Advantageously, the protective film is selected from the group consisting of plastics materials, resins or ceramics.

Flame retardants such as aluminium hydroxide, ammonium phosphate, chlorinated or brominated copolymers such as decabromodiphenyl ether (DecaBDE), tetrabromobisphenol A (TBBPA) or hexabromocyclododecane (HBCD) can also be added to the protective film.

Advantageously, the thickness of the protective film is less than 1 mm, preferably 0.02-0.3 mm. If the thickness of the protective film is greater than 1 mm, it influences the thermal, mechanical and also weight-specific properties of the graphite foil.

Advantageously, cooling is applied to the edge regions of the composite material, whereby heat can be dissipated even more quickly in the case of fire. All types of cooling, both active and passive, can be used. In the context of the invention, active cooling is understood to be the active dissipation of heat by forced convection or conduction with the aid of a cooling medium. This can be done, for example, by the edge region of the composite material containing pipes through which a cooling medium flows or by a gas flow flowing against the composite material. Passive cooling is the dissipation of heat by natural conduction or convection. For example, the cooling can take the form of a heat sink in the form of a metallic frame that can be provided with cooling fins, for example, to increase the surface area.

According to the invention, the fire protection panel is a fire protection door. Other possible applications for the composite material include use as walls of transport containers, e.g. insulated freight containers for refrigerated transport, as walls of box bodies for refrigerated transport vehicles, or also in battery housings for electrically powered vehicles or aircraft, an application where both the fire protection and insulation properties of the material are important.

### BRIEF DESCRIPTION OF THE DRAWINGS

In the following, purely by way of example, the present invention is described by way of advantageous embodiments and with reference to the accompanying drawings.

FIG. 1a is a perspective view of a composite material (1) having a graphite foil (2) or a perforated graphite foil (3).

FIG. 1b is a perspective view of a composite material (1) having a graphite foil (2) or a perforated graphite foil (3).

FIG. 1c is a cross section of a composite material (1) having a graphite foil (2) or a perforated graphite foil (3).

FIG. 1d is a cross section of a composite material (1) having a graphite foil (2) or a perforated graphite foil (3).

FIG. 2a is a perspective view of a composite material (1) having a graphite foil (2) or a perforated graphite foil (3) and in each case a protective film (5).

FIG. 2b is a perspective view of a composite material (1) having a graphite foil (2) or a perforated graphite foil (3) and in each case a protective film (5).

FIG. 2c is a cross section of a composite material (1) having graphite foil (2) or perforated graphite foil (3) and in each case a protective film (5).

FIG. 2d is a cross section of a composite material (1) having graphite foil (2) or perforated graphite foil (3) and in each case a protective film (5).

FIG. 3a is a perspective view of a composite material (1), where the perforated graphite foil (3) is located between two layers of fibres and matrix.

FIG. 3b is a cross section of a composite material (1) where the perforated graphite foil (3) is located between two layers of fibres and matrix.

### DETAILED DESCRIPTION

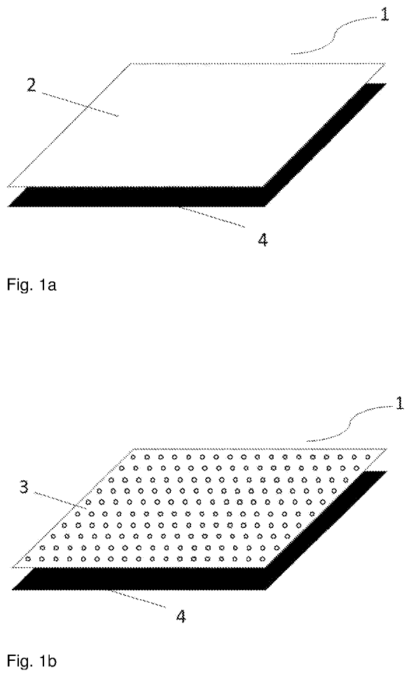

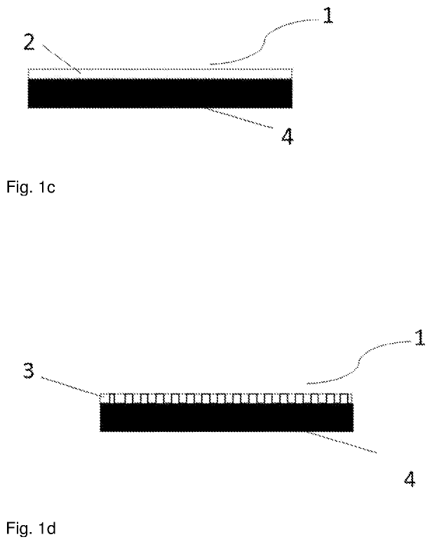

FIG. 1a is a perspective view of a composite material (1). A graphite foil (2) is applied to the layer made of fibres and a matrix (4). The layer made of fibres and a matrix (4) forms a form-fit connection with the graphite foil (2).

FIG. 1b is a perspective view of a composite material (2). A perforated graphite foil (3) is applied to the layer made of fibres and a matrix (4). The layer made of fibres and a matrix (4) forms a form-fit connection with the perforated graphite foil (3).

FIGS. 1c and d are in each case a cross section of a composite material (1) having a graphite foil (2) or a perforated graphite foil (3).

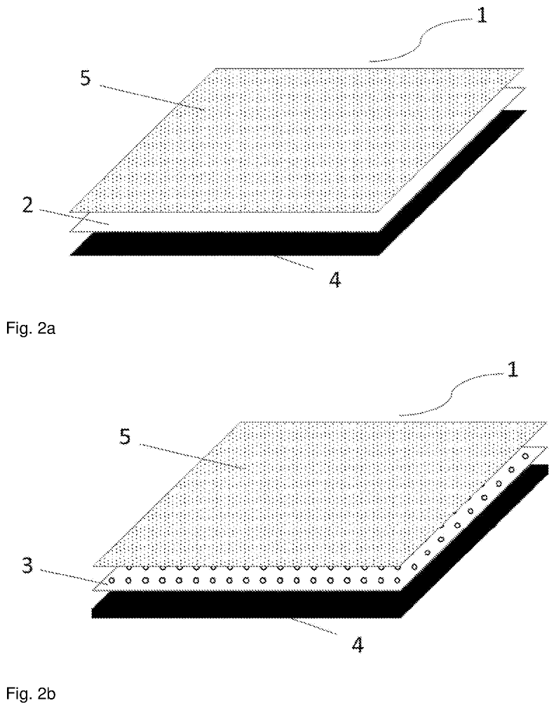

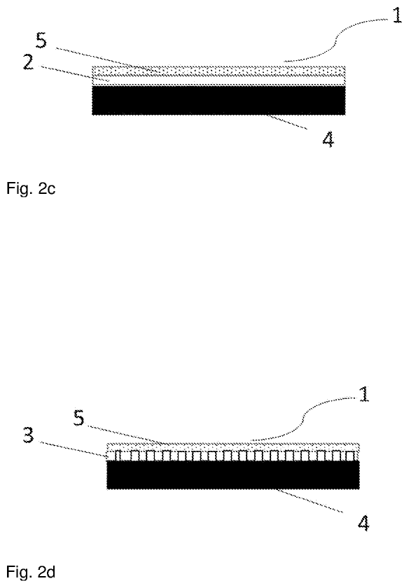

FIG. 2a is a perspective view of a composite material (1). A graphite foil (2) is applied to the layer made of fibres and a matrix (4), and a protective film (5) is applied to said graphite foil. The layer made of fibres and a matrix (4) forms a form-fit connection with the graphite foil (2).

FIG. 2b is a perspective view of a composite material (1). A perforated graphite foil (3) is applied to the layer made of fibres and a matrix (4) and a protective film (5) is applied to said graphite foil. The layer made of fibres and a matrix (4) forms a form-fit connection with the graphite foil (2).

FIGS. 2c and d are in each case a cross section of a composite material (1) having graphite foil (2) or perforated graphite foil (3) and in each case a protective film (5).

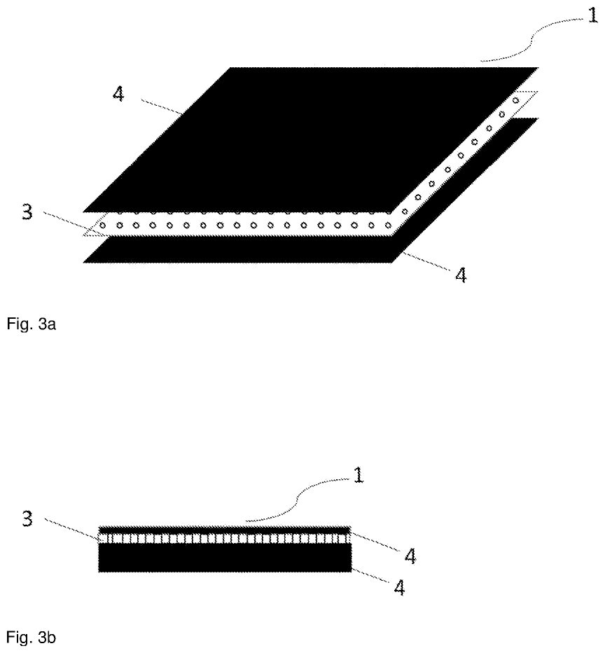

FIG. 3 is a perspective view of a composite material (1), where the perforated graphite foil (3) is located between two layers of fibres and matrix (4).

FIG. 3b is a cross section of a composite material (1) where the perforated graphite foil (3) is located between two layers of fibres and matrix.

The present invention is explained below using embodiments which, however, do not represent any limitation of the invention.

The production of a medical technology component can be carried out as described below.

### Embodiment 1

In one embodiment, a 2.5 mm thick composite material is fabricated for use as a flame retardant panel. For this purpose, eight layers of an epoxy resin prepreg having unidirectionally oriented carbon fibres and a fibre surface weight of 250 g/m² are stacked quasi-isotropically on top of one another in the 0°, 45°, 90°, −45°, −45°, 90°, 45° and 0° directions, whereby “quasi-isotropic” means that approximately the same mechanical properties are produced for the layer made of fibres and a matrix (4) in all directions within the plane. A 0.5 mm thick graphite foil (2) is also added as the top layer. Said graphite foil does not require a separate adhesive for adhesion, but rather adheres due to the material connection that is formed between the resin surface of the layer made of fibres and a matrix (4) and the graphite foil (2) during the curing process. For this curing process, the laid sheet is hardened for 2 h at a temperature of 130° C. under a pressure of 5 bar. This process converts the carbon fibre semi-finished product into a stable carbon fibre reinforced plastics material (CFRP) (layer made of fibres and a matrix (4) and combines this with the graphite foil (2) to form a form-fitting composite material (1). In the application, the graphite foil side faces a potential flame or heat source to achieve the best possible fire protection effect due to the heat distribution within the xy plane and the gas impermeability of the graphite foil (2).

### Embodiment 2

In a further embodiment 2, the procedure is analogous to that of embodiment 1, but a perforated graphite foil (3) is used. This 0.5 mm thick graphite foil (3) was provided, via a perforation process, with holes which are distributed homogeneously at equal intervals over the entire foil. The hole pattern has holes having a diameter of 1.3 mm and a hole spacing of 5.3 mm. This results in an open hole surface of 5.5%. Due to the flowability of the resin system and the applied pressure, resin is able to flow through these holes and thus form mechanically stabilising resin bridges to the comparatively weak perforated graphite foil (3). The internal strength within the graphite foil plane is therefore increased.

### Embodiment 3

In another embodiment, exactly the same structure as in embodiment 2 is used, but in addition, a 0.1 mm thick resin film is applied to the perforated graphite foil (3) as a protective film (5). The curing process is the same as in embodiment 2; the additional resin film ensures that a homogeneous protective film forms on the graphite foil, protecting the soft surface of the graphite foil against mechanical abrasion or scratches.

### Embodiment 4

In another embodiment 4, instead of an epoxy resin prepreg, a thermoplastic tape having carbon fibre reinforcement with polyamide 6 matrix is used as a precursor for the layer made of fibres and a matrix (4). These tapes also have a unidirectional fibre reinforcement having 250 g/m² fibre surface weight. The CFRP layer structure is placed in the same way as in the previous embodiments and a graphite foil (2) of thickness 0.5 mm is placed over it. In the subsequent processing step, the layers are consolidated for 20 minutes at 260° C. and under a pressure of 10 bar. The resulting laminate is shaped in a further processing step. For this purpose, the laminate is heated above the glass transition temperature by means of an infrared radiator, so that the thermoplastic matrix becomes mouldable again. By means of a robot arm, the soft structure is transferred into the desired press mould and brought into the desired geometry via a mould counterpart. Under a pressure of 30 bar, the laminate is cooled down again and can be taken out at a laminate temperature of 80° C.

### Embodiment 5

In another embodiment, the graphite foil is sandwiched between two layers of biaxial scrim made of carbon fibres having a basis weight of 290 g/m² each with the fibre orientation of +/−45°. The graphite foil having a thermal conductivity of 350 W/(mK) has a thickness of 0.6 mm and thus provides a sufficiently high thermal conductivity capacity for use as a heat dissipating heat dissipation panel. The graphite foil is provided with holes at intervals of 1.5 cm, the diameter of which is 2 mm. Epoxy resin mixed ready for reaction from resin and hardener (resin/hardener ratio of 100:21 parts by mass) at a temperature of 60° C. is applied to each of the two layers of scrim. The graphite foil is inserted between the two resin-coated layers of scrim and the complete stack is pressed into a mould heated to 120° C. for 3 minutes so that the resin impregnates the textiles and then cures. Resin passing through the holes in the foil provides the connection between the two layers of fibres and ensures that the graphite foil is firmly incorporated into the composite sheet. After completion of the pressing process, the manufactured fire protection panel can be removed from the mould.

### LIST OF REFERENCE SIGNS

(1) Composite material
(2) Graphite foil
(3) Perforated graphite foil
(4) Layer fibres and matrix
(5) Protective fil

1-15. (canceled)

16. A composite material comprising fibres and graphite foil for fire protection and/or heat dissipation panel.

17. The composite material according to claim 16, wherein the fibres and the graphite foil are each arranged as at least one layer on top of one another.

18. The composite material according to claim 16, wherein the fibres are embedded in a matrix.

19. The composite material according to claim 18, wherein the matrix is made of plastics material.

20. The composite material according to claim 19, wherein the plastics material is selected from the group consisting of thermoplastics, elastomers, duromers or mixtures thereof.

21. The composite material according to either claim 16, wherein the fibres are selected from the group consisting of carbon fibres, glass fibres, aramid fibres, metal fibres, ceramic fibres, natural fibres and basalt fibres or mixtures thereof.

22. The composite material according to claim 16, wherein the fibres are present in the form of short fibres, long fibres, continuous fibres, rovings, woven fabrics, scrims, nonwoven fabrics or mixtures thereof.

23. The composite material according to claim 16, wherein the graphite foil has a thickness of 0.15 to 2 mm.

24. The composite material according to claim 16, wherein the graphite foil has holes.

25. The composite material according to claim 24, wherein at least a some of the holes are at least partially filled with resin.

26. The composite material according to claim 16, wherein the graphite foil has a protective film.

27. The composite material according to claim 26, wherein the protective film is selected from the group consisting of plastics material, resins or ceramics.

28. The composite material according to claim 26, wherein the thickness of the protective film is less than 1 mm.

29. The composite material according to claim 16, wherein active or passive cooling is applied to the edge regions of the composite material.

30. The composite material according to claim 16, wherein the fire protection panel is a fire protection door, the walls of an insulated transport container or a battery housing.
